(19) United States
(12) Patent Application Publication
(10) Pub. No.: US 2002/0186179 A1
(43) Pub. Date: Dec. 12, 2002

(54) Optical display device

(76) Inventor: Gary R. Knowles, Ham Lake, MN (US)

Correspondence Address: HONEYWELL INTERNATIONAL INC., 101 COLUMBIA ROAD, P O BOX 2245, MORRISTOWN, NJ, 07962-2245, US

(21) Appl. No.: 09/876,317

(22) Filed: Jun. 7, 2001

(51) Int. Cl. G09G 5/00

(52) U.S. Cl. 345/8; 345/87

(57) ABSTRACT

An optical display including an eyepiece having two or more reflective segments for reflecting radiation from an image projector to a user's eye. The eyepiece also may have one or more transmissive segments, each of the transmissive segments disposed between at least two of the reflective segments, the transmissive segments allowing light from the ambient scene to enter the eye of the user. Since light from the ambient scene and also reflected light from the image projector reaches the user's eye, the ambient image and the displayed virtual image may appear to be superimposed.

### BACKGROUND OF THE INVENTION

1. Field of the Invention

Various embodiments of the present invention relate to a wearable display device and, more particularly, a see-through display device.

2. Description of Related Art

It is well known to mount small optical displays on eyeglasses, helmets, etc. Such optical displays allow images generated by a computer or another source to be viewed by users, and are useful for training, simulations, entertainment, and military applications. Further, these small optical displays typically produce an image that is superimposed on the ambient scene; that is, a user can simultaneously see the displayed image and the ambient scene beyond it. Optical displays may also be designed to obscure the ambient scene, so that a user only sees what is projected or presented by the display. Further, the displays may be designed to collimate or otherwise alter the light comprising the displayed “virtual” image so that it appears to be focused at a distance greater than the focal length of the system. For example, a small helmet-mounted display may produce a virtual image that appears to be ten feet away from the user even though it is projected onto an eyepiece or lens from a distance of less than 100 millimeters. This allows the user to view the ambient scene or the displayed image without refocusing his eyes.

Creating a virtual image focused well in front of the user may be accomplished either by projecting a collimated image onto a flat reflective surface or by projecting an uncollimated image onto or through an aspheric reflector, such as a parabolic mirror. For example, an uncollimated image may be projected onto a parabolic mirror to produce a virtual image that is focused at a finite distance, or at infinity. The use of a parabolic reflector in a collimating display can minimize aberration.

Typically, wearable displays use a single reflective eyepiece as the final optical element of the system. In order to keep the size and weight of these typical systems down, the eyepiece must not be very large. Consequently, the field-of-view of the displays is relatively narrow; for example, some previous displays have a field-of-view of about 15 degrees. In many applications, it would be desirable to have a wearable display that is light-weight, compact, and that still provides a wide field-of-view.

### SUMMARY OF THE INVENTION

An optical display that has an eyepiece is disclosed. The eyepiece, in turn, may have two or more reflective segments for reflecting radiation from an image projector to a user's eye. The eyepiece also may have one or more transmissive segments, each of the transmissive segments disposed between at least two of the reflective segments, the transmissive segments allowing light from the ambient scene to enter the eye of the user. Since light from the ambient scene and also reflected light from the image projector reaches the user's eye, the ambient image and the displayed virtual image may appear to be superimposed.

Throughout this description, the terms “transmissive” and “reflective” are used to clearly describe the primary characteristics of the segments. Those skilled in the art, however, will appreciate that it is not necessary for either segment to be fully reflective or fully transmissive. For example, the invention will still function if an exemplary eyepiece is opaque or is attached to an opaque lens or other structure. In such an embodiment, many of the advantages of the invention may still be realized although the ambient scene will not be visible. Such an embodiment would be applicable, for example, for entertainment purposed where it would not be necessary for a user to view an ambient scene in addition to a projected image. Further, in this embodiment, the “transmissive” segments may not actually allow light from the ambient scene to reach a user's eye, but instead function as spacers disposed between reflective segments.

In another embodiment, the reflective segments may be substantially, but not fully, reflective, thus allowing some light from the ambient scene to be transmitted to the user's eye through them in addition to the projected image. In this embodiment, distortion of the ambient scene may be reduced by embedding the eyepiece in a lens and covering it with an index-matched material.

Moreover, it is not necessary for light reflected by the reflective segments to be fully collimated. Fully collimated light will create a virtual image that is focused at infinity. Partially or substantially collimated light, however, can still produce a useful virtual image that is focused at a finite distance beyond the eyepiece.

These as well as other aspects and advantages of the present invention will become apparent to those of ordinary skill in the art by reading the following detailed description, with appropriate reference to the accompanying drawings.

### BRIEF DESCRIPTION OF THE DRAWINGS

Exemplary embodiments of the present invention are described herein with reference to the drawings, in which:

FIG. 1 is a simplified top view showing an eyepiece and an image projector that may be used in conjunction with the present invention;

FIG. 2 is an enlarged view of an exemplary eyepiece that illustrates the alternating transmissive and reflective segments of the eyepiece;

FIG. 3 is a further enlarged view of an exemplary eyepiece showing how some light may be reflected by and some light transmitted through the eyepiece;

FIG. 4 is a top view that shows an exemplary eyepiece attached to the surface of a typical lens;

FIG. 5 is a top view that shows an exemplary eyepiece formed in or attached to a recessed area of a typical lens;

FIG. 5A is a top view that shows an exemplary eyepiece formed in or attached to a recessed area of a typical lens with the eyepiece protected by optical material;

FIG. 6 is a simplified top view that shows an alternative embodiment of an eyepiece that has flat reflective surfaces for reflecting a collimated beam from an image projector;

FIG. 7 is a simplified user's view of an exemplary embodiment of the present invention integrated on a typical pair of eyeglasses; and

FIG. 8 is a top view that shows exemplary eyepieces and image projectors mounted on a typical pair of eyeglasses.

### DETAILED DESCRIPTION OF THE DRAWINGS

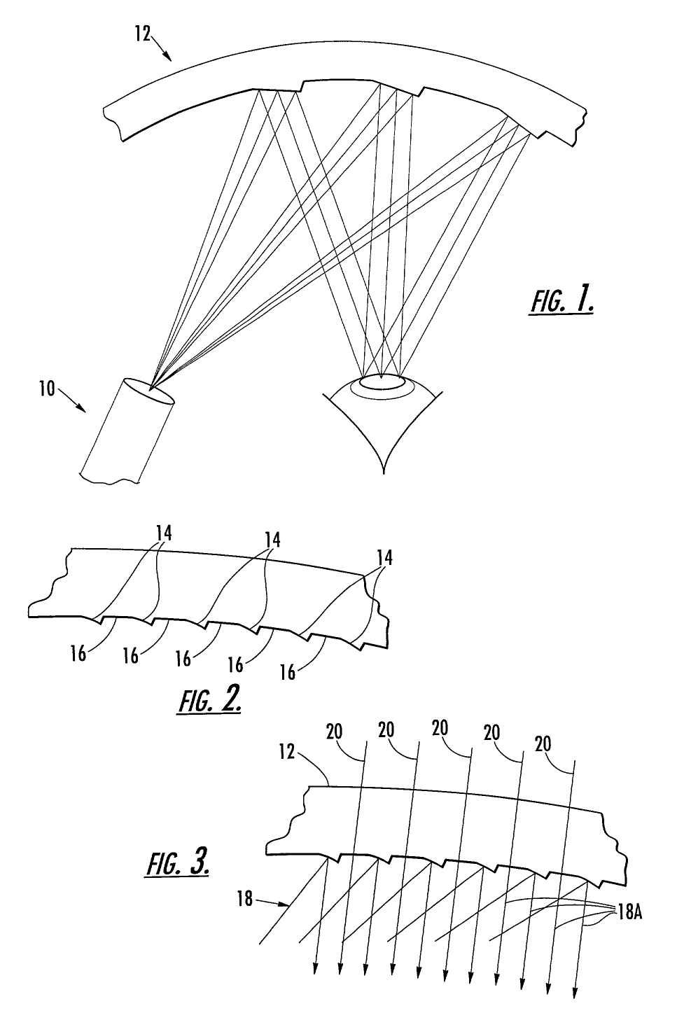

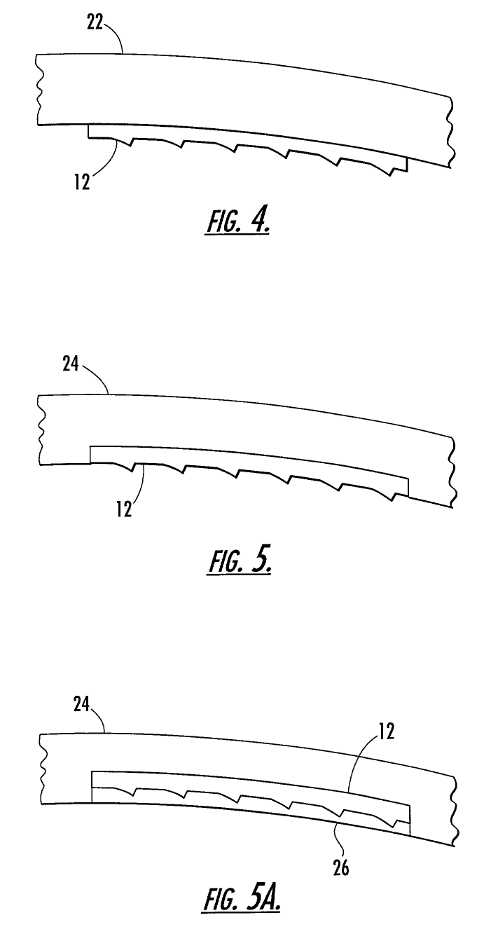

As shown in FIG. 1, an exemplary embodiment of the present invention may include an eyepiece 12 and an image projector 10. For clarity, the typical structure to which eyepiece 12 and image projector 10 may be mounted has not been illustrated in FIG. 1. Eyepiece 12 may include multiple reflective segments (better shown in FIGS. 2 and 3) that reflect a beam or beams projected from image projector 10 into a user's eye. Image projector 10 may either project a collimated or an uncollimated (i.e., a partially or substantially collimated) beam onto the reflective segments. Eyepiece 12 may be made of any optically suitable material such as optical plastic or glass. Eyepiece 12 may be the only lens of the exemplary display through which a user looks, or eyepiece 12 may be a separate component that is attached to another lens or structure. Thus, eyepiece 12 could be formed as (or attached to) a conventional eyeglass lens in order to fit into an eyeglass frame, or eyepiece 12 could even be formed directly in (or attached to) a helmet-mounted visor or a similar apparatus. FIG. 1 generally illustrates an embodiment of the present invention, and is not drawn to scale. Further, FIG. 1 shows reflected light beams that are collimated from every point in the user's field-of-view, and also illustrates the positional relationship between eyepiece 12 and image projector 10.

As discussed below, the present invention may be used to project either collimated or uncollimated light into an eye of a user. FIG. 1 is an exemplary embodiment only; it is not critical to the invention, for example, that the reflective segments be arranged as vertical strips, as shown. The invention will still function as described if the reflective segments are arranged in a checkerboard pattern, non-vertical strips, etc. Moreover, since the invention will function regardless of the arrangement of the reflective or transmissive “segments” described below, it should be noted that “segment”, as used herein, does not refer to any particular shape.

FIG. 2 is an enlarged view of a portion of eyepiece 12 that shows multiple reflective segments 14 interposed between multiple transmissive segments 16. For clarity, the projected and reflected beams have not been shown in FIG. 2. FIG. 3 illustrates the path of reflected and transmitted light in the exemplary embodiment of the invention. As shown in FIG. 3, light beams 20 from the ambient scene pass normally through transmissive segments 16 of eyepiece 12, while light beams 18 are projected from the image projector 10, and they are then reflected by reflective segments 14 (see FIG. 2) into an image processor, such as a user's eye or other light-receiving entity, as shown by reflected light beams 18A.

It should be noted that light beams 20 may be substantially unchanged by eyepiece 12. Alternatively, either eyepiece 12 or a lens to which it may be attached (not shown) can be a corrective lens; for example, eyepiece 12 may be attached to a conventional corrective eyeglass lens, or eyepiece 12 may be formed as a corrective lens, so that light passing through transmissive segments 16 is refracted to correct for any vision problems of a user. In addition, the invention could be used for an entertainment device, where the ambient scene is intentionally obscured (e.g., by a dark surface in front of or incorporated as part of the display). In such an embodiment, the projected image is all that a user would see.

Reflective segments 14 of eyepiece 12 may be precision ground or molded into the eyepiece using a mold that was precision ground using any technique capable of producing the required surface geometry. For example, modem diamond turning techniques allow for complex surfaces such as reflective segments 14 to be precisely machined directly on a structure such as eyepiece 12. Alternatively, diamond turning may be used to precisely machine a mold that can then be used to form eyepiece 12. Diamond turning or an equivalent technique can thus allow an eyepiece such as eyepiece 12 to be made with reflective segments that are narrower, more closely spaced, and more precise than may have been economically feasible using other technologies.

Precise forming of reflective segments 14 and transmissive segments 16 may allow virtually any practical spacing to be used. For example, the total distance from one reflective segment to the next could easily be less than the diameter of a user's pupil (typically 4 or more millimeters). When transmissive segments and adjacent reflective segments combined are less than or about equal to a user's pupil diameter, light from both the ambient scene and from the image projector may arrive at the user's eye collimated or substantially collimated. As an example, where reflective and transmissive segments are vertical, if the width of each reflective segment and an adjacent transmissive segment is less than the user's pupil diameter, the user may not be able to perceive the reflective segments of eyepiece 12, with the result that the ambient scene and the projected image appear to be smoothly combined. This image combining result may be obtained whether reflective segments 14 are fully reflective or partially reflective. This image combining result may be obtained regardless of whether or not the reflective segments 14 are embedded in the eyepiece 12.

An exemplary eyepiece of the present invention thus functions much like a fresnel lens. That is, the perceived image reflected off of the eyepiece into the user's eye is similar to the image that would be reflected off of a lens with continuous reflective surface. However, due to the close spacing of the reflective segments and due to the closeness of the eyepiece 12 to the user's eye (resulting in an inability to focus on the reflective segments themselves), the distortion typical of a fresnel lens will not be seen by the user. As an example, the eyepiece 12 may be worn in the range of 10-30 millimeters from the user's eye.

To minimize distortion, the surfaces of the reflective segments 14 may be aspheric. For example, the surfaces of the reflective segments may be parabolic or otherwise curved; virtually any surface that can reflect collimated or focused light into the user's eye will work. If reflective segments 14 are parabolic, placing image projector 10 (relative to each reflective segment) so that the apparent source of the projected image is near the focus of each parabolic section will produce collimated light. Further, the eyepiece 12 may still function even if the surfaces are spherical segments, although this may not be optimal due to the distortion that may result. Finally, the reflective segments 14 may be substantially flat. If the reflective segments 14 are flat, image projector 10 may project a collimated or uncollimated image onto them, which will then remain collimated or uncollimated after being reflected into the user's eye.

As mentioned above, eyepiece 12, and, more particularly, reflective segments 14, may be designed to reflect either collimated or uncollimated light into the user's eye. If the eyepiece 12 reflects collimated light, reflected light beams 18A will be parallel. Because reflected beams 18A are parallel, the projected image that results will appear to be focused at infinity, which may be useful for pilot's displays and the like, since an image that is focused at infinity allows a user to view both a projected image and a distant ambient scene without refocusing.

If reflected light beams 18A are uncollimated but instead converge at a point behind the user's eye, the projected image will appear to be focused at some distance in front of the user. The apparent distance at which a projected image appears in front of the user can of course be controlled by either the curvature of reflective segments 14 or by the optics incorporated in image projector 10.

Wearable displays made by others are generally limited to a relatively narrow field-of-view, due to their use of a single reflective surface. For example, if a see-through display is constructed using a single, partially reflective surface, the size of the required eyepiece and the image projection geometry may limit the field-of-view to about 15 degrees. The eyepiece of the present invention, on the other hand, can easily produce a field-of-view greater than 50 degrees in an integrated display that is not much larger or heavier than an ordinary pair of eyeglasses. Of course, an exemplary eyepiece of the present invention may also be used for much narrower displays as well.

FIG. 4 shows an exemplary eyepiece 12 mounted on the inner surface of a lens 22. Mechanical details have been omitted for clarity, but lens 22 may be a conventional corrective or non-corrective eyeglass lens mounted in an eyeglass frame (not shown). The eyeglass frame may be a conventional frame or it may be a frame specially made to satisfy the requirements of a display in accord with the present invention. For example, the frame may be made so that image projector 10 may be rigidly attached to it. Alternatively, lens 22 may be a visor which may be mounted (by means not shown) to a helmet or other structure worn by a pilot or other user.

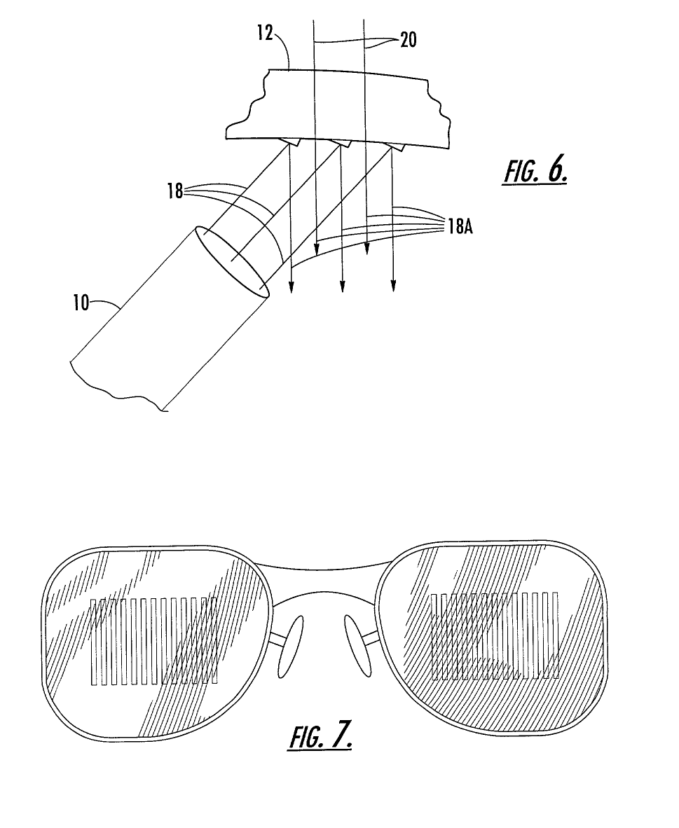

As shown in FIG. 5, eyepiece 12 may be mounted or formed in a recess in a lens 24 to protect the reflective segments 14 of the eyepiece. Similarly, FIG. 5A illustrates eyepiece 12 mounted or formed in a recess in lens 24 with the recess filled with optical plastic 26 that has an index of refraction that substantially matches the index of refraction of lens 24. Optical plastic 26 is not critical to the present invention, but serves to protect the reflective surfaces of eyepiece 12. Optical plastic 26 may thus be plastic, optical cement or even a pre-formed insert that covers eyepiece 12. The exposed surface of optical plastic 26 may then preferably be polished optically smooth. The resulting lens system 28 will function as described above (after any necessary adjustments are made for the additional refracting of light from image projector 10 by optical plastic 26). The lens system 28 of FIG. 5A may thus provide additional protection for the precision reflective segments 14 of eyepiece 12.

FIG. 6 illustrates an embodiment of the present invention where a narrow display results from using fewer reflective segments 14, where the reflective segments are also flat. In the embodiment shown, image projector 10 may project a collimated beam 18 onto reflective segments 14. In such an embodiment, light beams 18 will be parallel (i.e., collimated) to other light beams 18, and reflected light beams 18A will be parallel to other reflected light beams 18A as well. This will produce a relatively narrow image that is focused at infinity. The embodiment shown in FIG. 6 may be used in combination with any of the other features of the present invention, as described above. As an illustration, the embodiment of FIG. 6 may be used in the lens system 28 shown in FIG. 5A, and it may also be used with the eyepieces and mounting techniques shown in FIGS. 4 and 5.

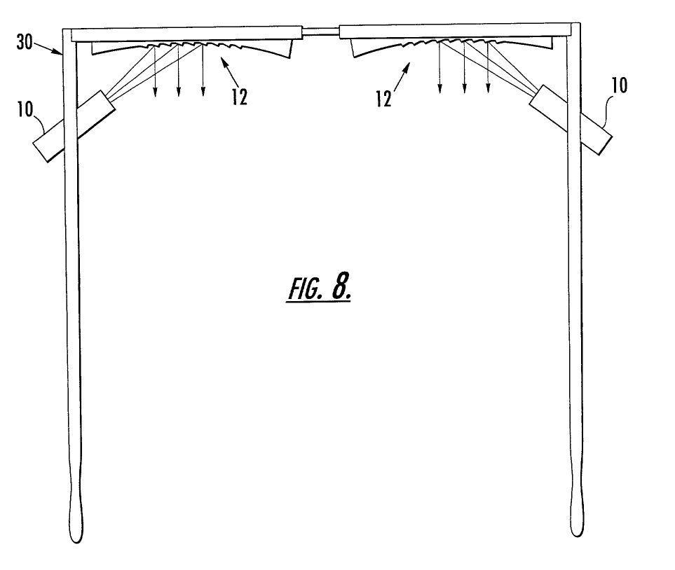

The present invention can easily be implemented with two eyepieces so that a user may see a projected image with both eyes, as in conventional wearable displays. A simplified illustration of this principle is shown in FIG. 7, where two eyepieces are mounted in an eyeglass frame. FIG. 8 shows an exemplary frame 30 with two image projectors 10 and two eyepieces 12 mounted to the frame 30 in fixed relation to the frame and to each other. Frame 30 may be a conventional eyeglass frame with hardware (not shown) used to mount image projector 10. Alternatively, frame 30 may be specially made to accept image projector 10. The mounting technique used for image projector 10 and for eyepiece 12 is not critical to the operation of the present invention. For example, image projector 10 may be mounted on the inside of a helmet or in any other manner that provides a fixed relationship with eyepiece 12.

Exemplary embodiments of the present invention have been illustrated and described. It will be understood, however, that changes and modifications may be made to the invention without deviating from the spirit and scope of the invention, as defined by the following claims.

I claim:

1. An optical display comprising:
an eyepiece having a plurality of reflective segments for reflecting radiation from an image projector to an image processor, each of the plurality of reflective segments including a reflective surface, the eyepiece also having at least one transmissive segment, the at least one transmissive segment disposed between at least two of the reflective segments, the at least one transmissive segment allowing light from an ambient scene to enter the image processor.

2. The optical display of claim 1, wherein the image processor is a user's eye.

3. The optical display of claim 1, wherein the reflective surfaces of the plurality of reflective segments are curved.

4. The optical display of claim 1, wherein the reflective surfaces of the plurality of reflective segments are substantially parabolic.

5. The optical display of claim 1, wherein the reflective surfaces of the plurality of reflective segments are substantially flat.

6. The optical display of claim 1, wherein the plurality of reflective segments are at least partially reflective.

7. The optical display of claim 1, wherein the eyepiece is attached to a lens.

8. The optical display of claim 7, wherein the eyepiece is attached to the lens in a recess in the lens.

9. The optical display of claim 8, wherein the eyepiece is covered by optical plastic that substantially fills the recess.

10. The optical display of claim 1, wherein the eyepiece is formed integrally as part of a lens.

11. The optical display of claim 10, wherein the eyepiece is covered by optical plastic.

12. The optical display of claim 1, further comprising an image projector mounted in fixed relationship to the eyepiece.

13. The optical display of claim 12, wherein the image projector projects a non-collimated beam onto the reflective segments and the plurality of reflective segments are curved in such a manner as to substantially collimate the reflected beams.

14. The optical display of claim 12, wherein the image projector projects a collimated beam and the plurality of reflective segments are flat.

15. An optical display comprising:
two eyepieces each constructed to be viewed simultaneously by two image processors, each eyepiece having a plurality of reflective segments for reflecting radiation from two image projectors to the image processors, each eyepiece further having at least one transmissive segment, the at least one transmissive segment disposed between at least two reflective segments, the transmissive segments allowing light from an ambient scene to enter the image processors.

16. The optical display of claim 15, wherein the image processors are a user's eyes.

17. The optical display of claim 15, wherein the reflective surfaces of the plurality of reflective segments are curved.

18. The optical display of claim 15, wherein the reflective surfaces of the plurality of reflective segments are substantially parabolic.

19. The optical display of claim 15, wherein the reflective surfaces of the plurality of reflective segments are substantially flat.

20. The optical display of claim 15, wherein the plurality of reflective segments are at least partially reflective.

21. The optical display of claim 15, wherein each eyepiece is attached to a lens.

22. The optical display of claim 21, wherein each eyepiece is attached to each lens in a recess in each lens.

23. The optical display of claim 22, wherein each eyepiece is covered by optical plastic that substantially fills each recess.

24. The optical display of claim 20, wherein each eyepiece is formed integrally as part of a lens.

25. The optical display of claim 24, wherein each eyepiece is covered by optical plastic.

26. The optical display of claim 15, further comprising two image projectors, each image projector being mounted in fixed relationship to one of the two eyepieces.

27. The optical display of claim 26, wherein each image projector projects a non-collimated beam and the plurality of reflective segments are curved in such a manner as to collimate the reflected beams.

28. The optical display of claim 26, wherein each of the image projectors projects a collimated beam and the plurality of reflective segments are substantially flat.

29. An optical display comprising:
an eyepiece having a plurality of reflective segments for reflecting radiation from an image projector to an image processor, each of the plurality of reflective segments including a reflective surface, the eyepiece also having at least one non-reflective segment, the at least one non-reflective segment disposed between and separating at least two of the reflective segments.

30. The optical display of claim 29, wherein the image processor is a user's eye.

31. The optical display of claim 29, wherein the reflective surfaces of the plurality of reflective segments are curved.

32. The optical display of claim 29, wherein the reflective surfaces of the plurality of reflective segments are substantially parabolic.

33. The optical display of claim 29, wherein the reflective surfaces of the plurality of reflective segments are substantially flat.

34. The optical display of claim 29, wherein the plurality of reflective segments are at least partially reflective.

35. The optical display of claim 29, wherein the eyepiece is attached to a lens.

36. The optical display of claim 35, wherein the eyepiece is attached to the lens in a recess in the lens.

37. The optical display of claim 36, wherein the eyepiece is covered by optical plastic that substantially fills the recess.

38. The optical display of claim 29, wherein the eyepiece is formed integrally as part of a lens.

39. The optical display of claim 38, wherein the eyepiece is covered by optical plastic.

40. The optical display of claim 29, further comprising an image projector mounted in fixed relationship to the eyepiece.

41. The optical display of claim 40, wherein the image projector projects a non-collimated beam onto the reflective segments and the plurality of reflective segments are curved in such a manner as to substantially collimate the reflected beams.

42. The optical display of claim 40, wherein the image projector projects a collimated beam and the plurality of reflective segments are flat.

43. An optical display comprising:
two eyepieces each constructed to be viewed simultaneously by two image processors, each eyepiece having a plurality of reflective segments for reflecting radiation from two image projectors to the image processors, each eyepiece further having at least one non-reflective segment, the at least one non-reflective segment disposed between and separating at least two reflective segments.

44. The optical display of claim 43, wherein the image processors are a user's eyes.
